(19) United States
(12) Patent Application Publication
(10) Pub. No.: US 2026/0200562 A1
(43) Pub. Date: Jul. 16, 2026

(54) A VIRTUAL FUEL CONSUMPTION SENSOR SYSTEM

(71) Applicant: CETASOL AB, Göteborg (SE)

(72) Inventors: Ethan FAGHANI, Göteborg (SE); Simon JOHANSSON, Sollentuna (SE)

(21) Appl. No.: 19/135,331

(22) PCT Filed: Dec. 5, 2023
(86) PCT No.: PCT/EP2023/084323

§ 371 Date: Jun. 3, 2025

(30) Foreign Application Priority Data
Dec. 6, 2022 (SE) 2230397-8

(51) Int. Cl. B63B 79/20; B63B 79/10; B63B 79/40

(52) U.S. Cl. CPC B63B 79/20; B63B 79/10; B63B 79/40

(57) ABSTRACT

A computer implemented method for determining a fuel consumption of a driveline (110) in a marine vessel (100), the method comprising generating a library (210) of fuel consumption models (220, 221, 222), where each fuel consumption model in the library of models is configured to predict fuel consumption of a driveline having a respective specification, where each fuel consumption model in the library of models is configured to operate based on a respective set of sensor input signals (115, 165), selecting one or more fuel consumption models from the library (210) based on a specification of the driveline (110) in the marine vessel (100) and on the available sensor input signals of the marine vessel (100), obtaining real-time physical sensor input signal data related to the driveline (110) in the marine vessel (100), and determining the fuel consumption of the driveline (110) in the marine vessel (100) based on the selected one or more fuel consumption models from the library (210) and on the obtained real-time physical sensor input signal data related to the driveline (110) in the marine vessel (100).

### TECHNICAL FIELD

The present disclosure relates to methods and control systems for determining real-time fuel consumption of a marine vessel lacking a sophisticated physical fuel consumption sensor.

### BACKGROUND

Emission reduction, specifically reduction of carbon dioxide (CO2) emission, is a focus in many transportation industries today, including the marine transportation segment.

To efficiently reduce emission, it is important to measure fuel consumption in real time or at least close to real time (on a time scale of seconds or minutes), such that fuel consumption optimizing measures can be taken to improve vessel handling from a fuel efficiency point of view.

Combustion engines, specifically large diesel engines, are very durable and normally last for a very long time before they need to be decommissioned. Hence, there are many old combustion engines in use today which lack the sophisticated fuel consumption sensor systems seen on modern combustion engines.

It is desired to measure real-time fuel consumption of legacy equipment in a cost-efficient and reliable manner.

### SUMMARY

It is an object of the present disclosure to provide techniques for determining real-time fuel consumption of a marine vessel. This object is obtained by the features set out in claim 1. By the features of claim 1 real-time data or at least close to real-time data on fuel consumption, i.e., on a time scale of seconds or minutes, may be obtained even for vessels that lack sophisticated physical fuel consumption sensor systems. The fuel consumption data is determined by the proposed system based on previous experience of similar engines using offline training and/or offline function parameterization, preferably in combination with online adjustment of the model or function. The “virtual” sensor systems disclosed herein may be referred to as detached sensor systems since there is no requirement of a physical sensor device which directly measures how much fuel that is consumed by the vessel. Because of this, the virtual sensor systems discussed herein can be operated on-board the vessel or remote from the vessel, e.g., on a remote server, which is an advantage.

The virtual fuel consumption sensor systems disclosed herein can be used as stand-alone fuel consumption sensor systems or in parallel with physical fuel consumption sensor systems to provide improved accuracy and/or redundancy. The virtual sensor systems disclosed herein can also be used to detect when a physical sensor system starts to output erroneous fuel consumption data, which is an advantage. Thus, the virtual fuel consumption sensor systems disclosed herein can be used in a safety system to ensure that primary fuel consumption sensors remain functional. Further advantages are obtained by the features set out in the dependent claims, as will be discussed in the following.

There is also disclosed herein control systems, vessels, computer programs, computer readable media, and computer program products associated with the above discussed functions and advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The above, as well as additional objects, features, and advantages, will be better understood through the following illustrative and non-limiting detailed description of exemplary embodiments, wherein:

FIG. 1 shows an example marine vessel with a fuel sensor system;

FIG. 2 illustrates a driveline fuel consumption model;

FIG. 3 is a graph illustrating model similarity;

FIG. 4 is a flow chart illustrating methods;

FIG. 5 schematically illustrates a control system; and

FIG. 6 shows an example computer program product;

### DETAILED DESCRIPTION

The present disclosure will now be described more fully hereinafter with reference to the accompanying drawings, in which exemplary embodiments are shown. The disclosure may, however, be embodied in many different forms and should not be construed as limited to the embodiments set forth herein; rather, these embodiments are provided for thoroughness and completeness. Like reference character refer to like elements throughout the description.

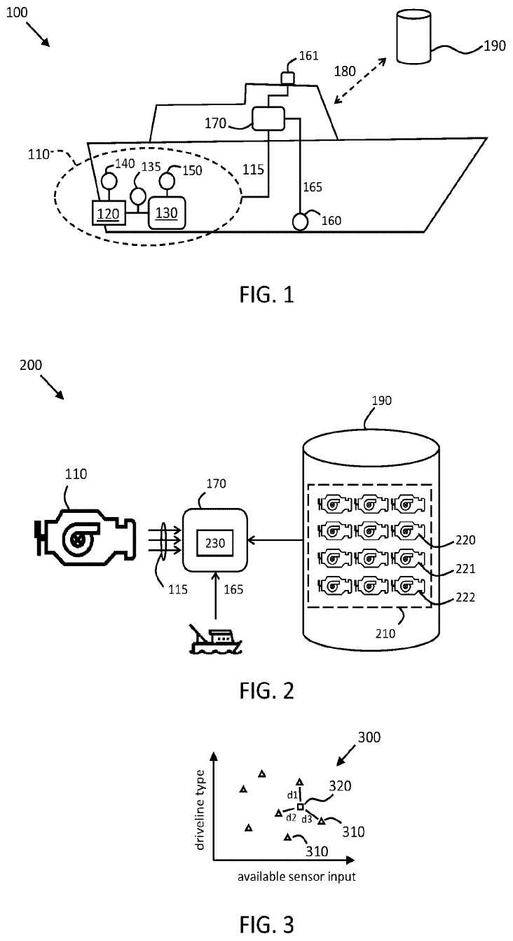

FIG. 1 illustrates an example marine vessel 100 comprising a driveline 110 and a control system 170 arranged to control the driveline 110 according to one or more control commands received from a vessel operator or from a navigation system of the vessel 100. The drivelines discussed herein may be manually controlled drivelines where a vessel operator provides throttle commands directly via an input device such as a lever or control knob, semi-automated drivelines where a computer system controls the engine speed and applied torque based on higher layer operator input commands, or fully autonomous systems where the operator only inputs, e.g., a desired destination or route to be traversed by the vessel 100.

The control system may comprise one or more control units, some, or all of which may be located remote from the vessel as remote servers or remote processing resources 190. Such remote devices may be connected to the vessel 100 via wireless link 180 in a known manner.

An optional vessel motion sensor system 160 may be arranged to measure motion parameters of the vessel 100 and report this data 165 back to the control system 170. The vessel motion data may comprise the speed through water (STW) of the vessel 100, vessel accelerations in lateral and longitudinal directions, as well as pitch, roll and yaw motion of the vessel 100. STW data can be obtained by a speed log or the like. Vessel acceleration data, including pitch, roll and yaw can be obtained from an inertial measurement unit (IMU). This type of data is normally correlated with the fuel consumption of the vessel and can therefore be used at least partly to estimate a current fuel consumption by the driveline 110. For instance, a vessel moving against current in strong headwind normally has a higher fuel consumption compared to the same vessel moving in the other direction, or in more calm seas.

The vessel 100 may also be equipped with a weather station 161 that measures, e.g., wind speed and rain. This weather data is also fed to the control system 170. The weather data thus obtained often has an impact on the fuel consumption of the driveline 110.

The control system 170 receives sensor data 115 from the driveline 110 related to an operating condition of the driveline 110. The exact type of sensor data 115 available to the control system differs between legacy vessels. Some vessels comprise a plurality of different sensors that together provide a low latency fine-grained view of the exact operating conditions of the, while other vessels comprise a more rudimentary set of sensors, perhaps only an engine speed sensor.

The driveline 110 comprises an engine 120 such as a gasoline, diesel, or crude oil combustion engine. The engine 120 is connected to a propulsion device, such as a propeller system or a water jet. The driveline 110 also comprises a fuel tank 130 from which the engine 120 draws fuel during operation. The fuel consumption of the engine 120 may be measured as an amount of fuel from the tank 130 consumed in a given amount of time, e.g., in terms of liters/min or kilograms/min. Fuel consumption can be measured over short or longer time periods. The type of fuel consumption referred to herein as real-time or close to real-time fuel consumption relates to engine fuel consumption on a second or minute time scale, i.e., a real-time fuel consumption will change significantly in response to an increased engine speed or torque. More long-term fuel consumption metrics comprise, e.g., the number of operating hours inbetween refueling and the decrease in fuel tank fill over longer time periods, such as fuel tank status change over the last hour, day, or so. Real-time fuel consumption data can be used to compare fuel efficiency of different maneuvers, which allows for fuel optimization by informing the vessel operator of the real-time fuel consumption associated with a given ongoing maneuver. This allows the vessel operator to adjust the vessel control strategy in order to efficiently reduce the fuel consumption of the vessel more efficiently than if only high latency feedback on fuel consumption is available.

The vessel 100 may comprise one or more sensor systems for monitoring various parameters of the driveline 110. The sensor set-up may as mentioned above differ significantly from one vessel to another. Some vessels have many sensors providing multiple real-time data points associated with the driveline 110, while other vessels only have a few sensors, perhaps just an engine speed sensor or data indicative of a current throttle setting of the engine. Different sensor types are also associated with different latencies, i.e., one vessel may be equipped with a very fast sensor system that provides more or less instant feedback on some driveline operating parameters, while another vessel may comprise a much slower sensor system where a significant delay is present from the onset of a change in operating condition to the time instant the change in operating condition becomes apparent at the control system 170. Some sensors also comprise low-pass filters, i.e., averaging filters which suppress transients and fast variations in order to suppress noise. Data from such sensors cannot normally be used to measure real-time fuel consumption since the real-time data is filtered out, leaving only long-term trends in the data. An important component of the teachings herein is that engine fuel consumption is modelled by engine models which also account for the available sensor input signals. Hence, one model may be based on engine speed to predict engine fuel consumption in real-time, while another model for the exact same engine may instead be based on engine torque or combustion pressure to predict fuel consumption in real time. The most suitable model for predicting real-time fuel consumption is then selected based on the available sensor signals of a given legacy vessel. This is an advantage since the same software can be used with different types of vessels having different sensor set-ups. It is also an advantage that the software functions discussed herein can adapt in case one or more sensors stop delivering reliable data. Thus, a vessel that starts out with an advanced sensor set-up may experience sensor malfunction, ending up with a limited sensor array to measure fuel consumption by the driveline. The techniques disclosed herein can then be used to maintain reliable monitoring of fuel consumption by activating a virtual fuel consumption sensor system.

The virtual fuel consumption sensor systems discussed herein can also be used to monitor the output from a physical fuel consumption sensor system. Thus, a virtual fuel consumption sensor system can be operated in parallel with the physical one, and the outputs of the two systems can be compared. In case of a discrepancy a warning signal can be triggered, prompting an operator or service technician to investigate if the physical fuel sensor system is operating correctly. In other words, with reference to the discussion below, there is disclosed herein a computer implemented method for monitoring an output of a physical fuel consumption sensor system configured to monitor a fuel consumption of a driveline 110 in a marine vessel 100. The method comprises
generating a library 210 of fuel consumption models 220, 221, 222, where each fuel consumption model in the library of models is configured to predict fuel consumption of a driveline having a respective specification, where each fuel consumption model in the library of models is configured to operate based on a respective set of sensor input signals 115, 165,
selecting one or more fuel consumption models from the library 210 based on a specification of the driveline 110 in the marine vessel 100 and on the available sensor input signals of the marine vessel 100,
obtaining real-time physical sensor input signal data related to the driveline 110 in the marine vessel 100,
determining the fuel consumption of the driveline 110 in the marine vessel 100 based on the selected one or more fuel consumption models from the library 210 and on the obtained real-time physical sensor input signal data related to the driveline 110 in the marine vessel 100, and
monitoring an output of the physical fuel consumption sensor system by comparing its output to the fuel consumption of the driveline determined based on the selected one or more fuel consumption models from the library 210 and on the obtained real-time physical sensor input signal data related to the driveline 110 in the marine vessel 100. This comparison may be just a threshold operation applied to the difference between the outputs, or a more advanced acceptance criteria test involving one or more different acceptance criteria metrics, such as variance of the difference, a magnitude of the difference, and so on. The acceptance criterion can, generally, be defined off-line using practical experimentation and computer simulation of acceptable deviations from some ideal performance.

Referring to FIG. 1, an engine sensor system 140 may be connected to the engine 120 in order to measure various operating parameters of the engine 120, such as engine speed (rpm), engine load, motor axle torque, engine boost pressure, engine turbo pressure, engine boost temperature, exhaust temperature, exhaust pressure, temperatures at different places, and generated engine noise, all of which are normally correlated with fuel consumption of the driveline 110. Sensor devices for measuring these operating parameters are known and will therefore not be discussed in more detail herein. The engine sensor system 140 is connected to the control system 170, i.e., the control system 170 continuously or periodically receive sensor signals from the various engine sensors 140.

A fuel tank sensor system 150 may be arranged in connection to the fuel tank 130 to provide data regarding current tank status, e.g., in terms of remaining fuel volume or remaining fuel weight. The fuel tank sensor system 150 is also connected to the control system 170. The sensor set-up may furthermore comprise a fuel consumption sensor 135 arranged to measure a flow in the fuel line from the tank 130 to the engine 120. This is setup would allow for a more accurate correction to be applied to the fuel model as it could tune continuously while running. This can also be done by providing fuel consumption estimates over different time intervals while the model is running. These types of adjustment will improve the absolute accuracy of the virtual fuel consumption sensor.

The sensor signals described herein may comprise both digital messages, such as packets transmitted via Controller Area Network (CAN) bus or Ethernet media, and analog signals, such as a voltage signal. The sensor systems discussed herein can be wired to the control system 170 or connected to the control system 170 via wireless link.

The control system 170 is as mentioned above optionally connected via wireless link 180 to one or more online resources, such as the server 190, which may form part of a cloud-based system of information sources. The server may also form part of the information processing system of the vessel 100, i.e., the server 190 may in some cases assist the control system 170 in performing various computation tasks and data storage operations.

It is desired to measure the fuel consumption of the vessel 100. This can, as mentioned above, be achieved by measuring the operating time between refueling of the tank 130 and/or by observing slow changes in fuel tank status using a tank level gauge comprised in a fuel tank sensor system 150. These measurements are, however, often too crude and are associated with too high latency in order to be used successfully for fuel consumption optimization purposes on a more fine-grained real-time level. To successfully optimize fuel consumption, real-time data of fuel consumption is preferred, or at least close to real-time data. If such real-time data of fuel consumption is available, then an operator can receive instant feedback of fuel consumption during maneuvering, and thus improve the vessel maneuvering with an objective to reduce the fuel consumption of the vessel 100.

Real-time data regarding vessel fuel consumption is often not available on older vessels which are powered by legacy combustion engine equipment. In order to install an energy monitoring system in those legacy systems, one normally installs third party fuel flow measurements. Such third party fuel flow measurements are rather expensive, and they also need careful calibration in order to provide reliable output.

FIG. 2 schematically illustrates an alternative to installing third party physical fuel consumption measurement systems.

FIG. 2 shows a virtual fuel consumption sensor system 200 that can be used to execute at least some of the methods described herein. The system 200 comprises a library 210 of fuel consumption models 220, 221, 222. Each fuel consumption model 220, 221, 222 in the library of fuel consumption models 210 is a function which outputs a real-time fuel consumption for a given type of engine based on a model-specific set of input signals. A fuel consumption model 220 may, e.g., be configured to predict real-time fuel consumption of a certain six-cylinder diesel engine of a given combustion chamber volume based only on engine speed. Another fuel consumption model 221 may be configured to predict the real-time fuel consumption of the same six-cylinder diesel engine, but based on another set of input signals, such as engine speed and engine torque. A third fuel consumption model 222 may relate to an entirely different type of combustion engine compared to the first and second models in the library 210.

The library of engines is the basis of the further modelling. Those engines are themselves accurately modelled individually. To ensure the quality and usability of those, they are based on time resolved data on a sufficiently small scale to capture the fuel consumption correlation with the rest of available engine parameters. This time scale would for example be on the order of 10 seconds or so. Those models are as complex as need be to ensure sufficient accuracy for the modelled fuel consumption. In this stage the models can span from a simple look-up table to more advanced models such as deep neural networks as the only limiting factor is enough training data to ensure quality of that specific engine model. The training data used for the more advanced models can for example be generated from experimentation using test benches in laboratory environments or real time sessions of active engines in vessels. The main objective is to capture a wide range of operational conditions for the engine itself and all available sensor data. These models will then be set up with different sensor values to ensure a wider library for later stages, to allow legacy vessels with as few or many sensors available. Those models will be able to describe the fuel consumption value with different grades of accuracy for a specific engine and specific input sensor data.

To enable real time optimization in other applications using the predicted fuel consumption, this prediction needs to have a high correlation in the entire operational range. This also includes transition periods between more commonly represented states in the operational range of the engines. These transition periods are hard to capture in basic fuel consumption models and require more sophisticated models to capture the complex relationship between transition and fuel consumption. This is where artificial intelligence (AI) modelling tools can be used to describe this more complex behavior and allow a transfer of knowledge between engines in the same group. Simpler models and look-up tables are limited to steady state estimations, but this is possible to extend with the use of more sophisticated modelling tools and robust mapping setups.

The engine library models will mainly focus on driveline specific sensors as mentioned earlier but can also be extended to environmental parameters. This for example can be to capture resistance in the driveline from external data that can then be mapped to a resistance parameter for the engine itself.

Each model may be realized as a function of one or more input sensor signals indicative of a current operating condition of the driveline 110. Each model may also be configured to account for more general vessel operating conditions when predicting fuel consumption, such as wave height, sea current, and the like.

To summarize, the more advanced fuel consumption models 220, 221, 222 can be implemented using an artificial intelligence (AI) structure, sometimes referred to as a machine learning (ML) function. AI models can for instance be neural network models (NN), convolutional neural networks (CNN) or recurrent neural networks (RNN). According to an example, a data set from each modelled engine is obtained and divided into a training part and a verification part. The training part of the data can be used to train the AI structure using known methods, and the verification part is then used to determine if the engine model provides sufficiently accurate predictions of fuel consumption using sensor input data. The number of layers used in the AI structure can be decided based on model performance for the verification data. Those models will not be trained on the same data that is provided from the vessel where the virtual fuel consumption sensor is to be applied, but rather on reference vessels with a much larger input data for training and validation. This allows the models trained here to capture all important features of both steady state and transient behaviors of the engines.

In other words, to build the library 210 of fuel consumption models 220, 221, 222, data sets comprising various sensor input signals (such as engine speed, torque, combustion pressure, etc) and corresponding fuel consumption data is obtained. The obtained data set is then divided into a training part and a verification part. Practical experimentation using obtained data can be performed in order to determine a suitable split between the data amount in the training part and the data amount in the verification part. The selected AI structure is then trained using the training part using known methods, and the end result is verified using the verification part. During training, the AI structure is stimulated using the sensor input signals of the data set, and the corresponding fuel consumption is used to adapt the model. During verification, the sensor data is input to the trained structure and the output predicted fuel consumption of the model is compared against the actual fuel consumption data of the data set. The difference there in-between is used to quantify the performance of the model in predicting fuel consumption for a given engine type and for a given set of input sensor signal types.

Less complex models can of course also be used as an alternative to the more advanced AI-based models or as a complement to the AI-based models in the library 210 of models. Such less complex models may comprise, e.g., linear regression models, polynomial regression models, K-nearest neighbor algorithms, decision tree models, gradient boosting decision trees, and random forest based methods. Training and verification of each model type will be different but in general the concept will be to find the simplest model, e.g., minimum polynomial degree which gives an acceptable accuracy.

An even less complex engine model can be realized as a simple look-up table, where one or more engine operating parameters are mapped directly to predicted fuel consumption. Thus, for a given model of engine by a given manufacturer, fuel consumption data as function of, e.g., engine speed and engine torque may be tabulated and used as the engine model.

Each model may also be associated with a list of engine models from specified manufacturers. This list is then indicative of which engines that are accurately modelled by the given model. The list can then be used to select an appropriate engine model from the library by matching a given legacy engine with an entry on the list. This will reduce the complexity of the mapping function that will later be applied to match the new vessel engine with the engine from the library. The closer the engine matches, the more reliable the library model is itself, and for directly matching engines the mapping function might allow for a one to one condition.

It is appreciated that the library 210 may comprise a variety of different types of models, e.g., a couple of the engine models 220, 221, 222 in the library may be advanced AI-based models, while some other models in the library are less complex models based on regression techniques, and yet other models in the library 210 are provided as simple look-up tables of fuel consumption as function of one or more engine operating parameters. Thus, the library 210 may be diverse in the sense that it comprises models of different types.

According to some aspects, complexity is used as a factor in selecting which model or combination of models to use. Simple models are often based on less complex models of the physical world compared to more advanced models. Straight-forward look-up tables are for instance normally populated by values obtained from practical tests. The less complex models can thus be used to verify that the output of the more advanced models are within reasonable bounds. In other words, there is disclosed herein a computer implemented method for determining a fuel consumption of a driveline 110 in a marine vessel 100. The method comprises generating a library 210 of fuel consumption models 220, 221, 222 of varying complexity, where each fuel consumption model in the library of models is configured to predict fuel consumption of a driveline having a respective specification, where each fuel consumption model in the library of models is configured to operate based on a respective set of sensor input signals 115, 165. One of the models may, e.g., be based on a look-up table while another model is based on an advanced AI structure. The method comprises selecting a first model set comprising one or more fuel consumption models from the library 210 based on a specification of the driveline 110 in the marine vessel 100 and on the available sensor input signals of the marine vessel 100. The method also comprises selecting a second model set comprising one or more fuel consumption models from the library 210 based on a specification of the driveline 110 in the marine vessel 100 and on the available sensor input signals of the marine vessel 100. The models in the first set are more complex than the models in the second set, e.g., the models in the first set may be models that depend on training data while the models in the second set may be models that are configured using practical experimentation. The method also comprises obtaining real-time physical sensor input signal data related to the driveline 110 in the marine vessel 100 and determining the fuel consumption of the driveline 110 in the marine vessel 100 based on the selected one or more fuel consumption models in the first set and in the second set, and on the obtained real-time physical sensor input signal data related to the driveline 110 in the marine vessel 100. The method also comprises comparing the determined fuel consumption by the models in the first set and by the models in the second set and triggering an action in case of a too large discrepancy, i.e., a discrepancy which fails to meet an acceptance criterion. The action may be a warning signal, or some more advanced action, such as a reconfiguration of the more advanced model. A software update to a better suited library of models may also be warranted in case a too large discrepancy between the more advanced and the less advanced model set is detected.

To use the system 200 in predicting real-time fuel consumption of a legacy vessel such as the vessel 100, a driveline model 230 is constructed from the library of models 210. This driveline model 230 accounts for the type of driveline 110 that the vessel 100 has, including aspects of its engine 120 and fuel system 130. In some cases, the exact driveline type is already represented by a model in the library of models 210. In other cases, there is no exact match in the library of models which fit the vessel driveline exactly. The model construction also accounts for the sensor data available on the vessel 100. Some vessels have many sensors installed, while other vessel only have very few data sources operational, some only provide engine speed. It does not make sense to select a model which operates based on sensor signals which are not available on the vessel 100. Also, as noted above, physical sensors may malfunction, leaving a reduced sensor suite for determining fuel consumption. Consequently, a model 220, 221, 222 is selected from the library of models in dependence of the driveline type and also in dependence of the driveline sensor data available on the vessel 100.

The library of models 210 comprises models of different driveline types and with different sensor data inputs and is constructed offline. The graph 300 in FIG. 3 illustrates this two-dimensional library structure, where triangles 310 illustrate the different models in the library, and the square 320 represents the driveline and sensor configuration of a target vessel 100.

The library of models will use a mapping function that is calibrated to the target vessel. This mapping function will use the library engine in such a way that data ranges are defined for each signal and the engines operational spectrum can be described in a general way. This spectrum can then be created for the vessel to be modelled as well. Once the engine from the library and the engine from the vessel are described in a generic way, independent of exact sensor, in terms of ranges, those spectrums can be matched together. This matching will be done by using a mapping function between engines. This mapping function will take as input a state in one engine with given sensor data and output how the fuel consumption would be affected for the same state in the other engine. This mapping will be trained on the same engine library to model how fuel consumption is affected when traversing between engine models as well as on the vessel to be deployed at. The main target of this mapping function is to capture non-linearities between engine types, were the total consumption should remain the same but different areas in the operational spectrum will give different contributions if one engine assumes the role of another.

The mapping function will be based on data driven decisions in terms of how the engines in the library correlate, or on logical structures based on know-how. For example, the mapping could be constructed in such a way that for a special engine setups and operational behavior the engine in question might consume more in certain regions of operation compared to the library model. This could then be encoded by increasing the total fuel consumption in that region and reducing it in the remaining parts of the operational range to still ensure the accumulated targets are met. The mapping function also includes information about distributional knowledge of the engine operation. This means that the operation distribution of a target vessel can be mimicked in a known engine from the library and with this the mapping function can adjust accordingly. This assists in terms of using an engine model from the library that is tested in a wide range of operations to how it would look for a more specific operational setup that would be used in the new vessel.

To ensure that the library models perform well on the new vessel this mapping function plays an important role in terms of tuning. This is the function that can use accumulated external measurement to map the library models accordingly to what can be measured onboard. The fact that no time series data for the fuel consumption will be available onboard in a wide set of the vessels, this tuning capability will play an important role to adjust the accumulated fuel values to match reality. Nevertheless, the relation between operational conditions will always indicate trends in fuel consumption even without perfectly tuned accumulated values.

Some legacy vessel drivelines and sensor systems will as mentioned above find an exact match in the library 210, i.e., the square 320 will be exactly overlapping a triangle 310 in both for driveline type and for available sensor data on the legacy vessel. In this case the corresponding model will simply be identified in the library of models and loaded into the control system 170 of the vessel 100 as the driveline model 230. Note however, that such systems may still benefit from the other models in the library in case, e.g., a physical sensor malfunctions. In this case a set of models can be used instead of the perfectly matching model (which is now not applicable due to the loss of sensor signal). By selecting a plurality of fuel consumption models from the library based on the specification of the driveline 110 in the marine vessel 100 and on the available sensor input signals post-malfunction, the fuel consumption can still be determined reliably.

Other legacy drivelines will not be represented exactly in the library of models 210 from the start. This case is more difficult and may involve a selection of several models which will be used jointly as the driveline model. A given number of models are then selected from the library of models and used jointly as the driveline model 230. In the illustration graph 300, the three “closest” models are selected, and the predicted fuel consumption will be a weighted combination of the three selected models. A distance d1, d2, d3 between two models can be defined based on difference in specification between the modelled engines, i.e., difference in number of cylinders, difference in combustion chamber volume, difference in injection technology, and so on. The distance will also account for the available sensor signals on the legacy vessel and the sensor input signals used to define the model in the library 210. For example, to determine the distance between legacy engine i and engine model j in the library, each data point, i.e., each engine specification point, and each sensor input signal may give rise to a distance contribution

$${d}_{i , j}^{k}$$

with a weight wₖ, and the total distance d_{i,j} can then be determined as

$${d}_{i , j} = \frac{1}{\sum {w}_{k}} {\sum }_{k = 1}^{K} {w}_{k} {d}_{i , j}^{k}$$

Some data points may be assigned fixed distance contributions, and some specific differences between the legacy vessel driveline and an engine model will be directly disqualifying. A directly disqualifying difference means that the “distance” between legacy engine and engine model is infinitely large which disqualifies the engine model from use. This may, e.g., be the case if a model depends to a great deal on some specific type of input sensor signal which is not available on the legacy vessel.

The fuel consumption of the driveline 110 in the marine vessel 100 can be determined as a weighted combination of respective outputs from a plurality of fuel consumption models from the library 210, selected, e.g., based on the distance metrics discussed above, and on the obtained real-time physical sensor input signal data related to the driveline 110 in the marine vessel 100. A plurality of fuel consumption models are then executed in parallel using the available sensor input signals of the vessel, and the output from the different models is then weighted together into the final predicted fuel consumption of the vessel. The weights can be determined by practical experimentation using the long term calibration data (such as tank level data), or by using the distance metrics between models and the vessel driveline discussed above.

To give an example, the techniques disclosed herein may initially comprise a sequence of model preparation steps: Fuel consumption, usually presented at liters/h or liters/min, can be predicted with high accuracy (95-99%) in standard production conditions.
1. The first step is to create a library 210 of different engines. The library comprises a plurality of engine models, where each model comprises aspects of engine specification as well as available sensor input signals. This library can be expanded with more and more models over time as such models become available. Two or more models in the library can be used jointly to model the fuel consumption of a legacy engine which is not represented in the library of engine models.
2. The second step is to create a correlation matrix for fuel consumption based on different sets of sensor signals. The correlation matrix shows which signals that are indicative of fuel consumption for a given driveline type and specification. To reduce complexity in the library, only the sensor signals above a correlation cut-off threshold will be used, i.e., sensor signals which only correlate weakly with fuel consumption will be ignored.
3. All of the sensor input signals, and all of the model outputs (predicted fuel consumptions) is optionally normalized (e.g., to a value between zero and one, where zero represents the minimum fuel consumption and one the max fuel consumption value). E.g., for engine speed the minimum is idle speed and maximum is max theoretical engine speed.
4. For each case, different models will be created with different combinations of input sensor signals. One model can be configured to estimate fuel consumption based only on engine speed, while another model for the same engine type can be configured to estimate fuel consumption based on a combination of engine speed and engine torque. A third model for the same engine type can be configured to also account for engine noise, and/or engine operating temperature. A fourth model may be configured to account for combustion pressure, and so on. One or more models may also account for the current motion by the vessel, weather conditions, and so on. This data can be obtained from on-board sensors as discussed above in connection to FIG. 1.
5. The models will be used to predict the dependency of fuel consumption on different engine characteristics, e.g., engine size, number of cylinders, injection technology used etc.
6. For each target driveline, a model or a combination of models will be selected from the library of models 210 and loaded into the control system 170 as the driveline model 230 of the vessel 100. The model is then optionally calibrated during use, based on available data of fuel consumption, such as tank level gauge data or operating time between refueling of the vessel. The calibration data used can be of the slower type, i.e., slow fuel tank readings or measurement of time in-between refueling of the vessel.
7. The engine model output can, for instance, be a normalized value between zero and one, and thus in need of scaling with more slow sensor measurements of fuel consumption. This is where the mapping function will be applied to ensure the model output matches the expectations for the active vessel.
8. The driveline model 230 can be calibrated using different methods. The driveline model 230 can, for instance, be calibrated using an integrated fuel consumption value from the engine model over a period of time compared with actual fuel added to the tank, e.g., when an amount of purchased fuel is known.

This tuning would improve the absolute performance of the mapping function translating the library engine/engines to this new specific engine setup.

The driveline model 230 can also be calibrated at least in part by using slower signals like fuel tank sensors and integrating the slow changing signals over fixed time period, e.g., one hour. A well calibrated fuel flow sensor 135 can of course also be used. According to some aspects, an expensive fuel flow sensor is used initially at some legacy vessel during a calibration phase and then removed from the vessel once calibration has been completed. This way expensive fuel flow sensors can be re-used on more than one legacy vessel, which is an advantage.

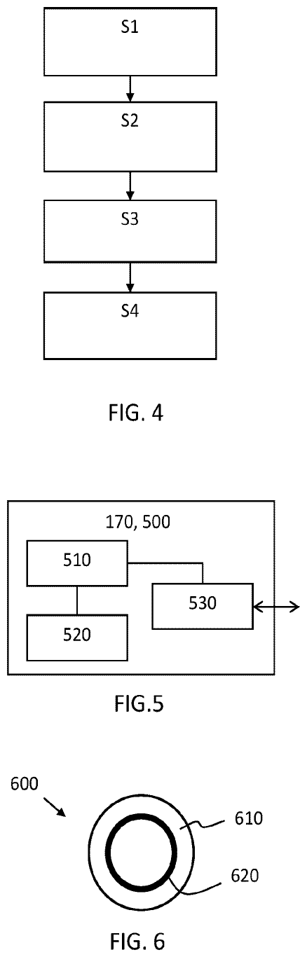

FIG. 4 is a flow chart which illustrates methods that summarize the above discussion. There is illustrated a computer implemented method for determining a fuel consumption of a driveline 110 in a marine vessel 100, such as the driveline 110 of the vessel 100 discussed above in connection to FIG. 1. The method comprises generating S1 a library 210 of fuel consumption models 220, 221, 222, where each fuel consumption model in the library of models is configured to predict fuel consumption of a driveline having a respective specification, i.e., a given set of data sheet specifications, where each fuel consumption model in the library of models is configured to operate based on a respective set of sensor input signals 115, 165. Thus, as discussed above, each engine model in the library of engine models corresponds to a given type of engine having given characteristics, such as a specific number of cylinders, combustion chamber volume, manufacturer, etc. Each engine model is also associated with a specific set of sensor input signals which represent the input to the model. These sensor input signals, or real-time physical sensor input signal data, may comprise any of; engine speed, engine load, torque, engine boost pressure, engine turbo pressure, engine boost temperature, exhaust temperature, exhaust pressure or a combination of pressures and temperatures at different places.

The method also comprises selecting S2 one or more fuel consumption models from the library 210 based on a specification of the driveline 110 in the marine vessel 100 and on the available sensor input signals of the marine vessel 100. In case the exact engine and sensor set-up exists in the library then that model is selected as the driveline model 230. When there is no exact engine model in the library then, according to an example, all the non-related engines are removed from the selection map, e.g., engines with different stroke (2 or 4), injection technology or engines with no similar sensors available. The legacy engine can then be characterized by its size and max power, whereupon an interpolation in-between models is done to find the suitable trade-off between models in the library. According to an example engines of the same brand are more heavily weighted in this type of model fusion. It is noted that physical sensors may malfunction. In case this happens a new set of fuel consumption models can be selected, where the malfunctioning sensor signal is not used.

The method also comprises obtaining S3 real-time physical sensor input signal data related to the driveline 110 in the marine vessel 100 and determining S4 the fuel consumption of the driveline 110 in the marine vessel 100 based on the selected one or more fuel consumption models from the library 210 and on the obtained real-time physical sensor input signal data related to the driveline 110 in the marine vessel 100.

As discussed above, two different sets of models can be selected, where one model is less advanced compared to the other. This way the less advanced model can be used as sanity check on the more advanced model, by comparing the two outputs and ensuring that the discrepancy always satisfies an acceptance criterion such as a threshold.

According to some aspects, the real-time physical sensor input signal data also comprises any of; vessel speed through water (STW), vessel pitch roll and/or yaw, vessel longitudinal acceleration, and vessel lateral acceleration.

The method may also comprise adjusting S5 the determined fuel consumption of the driveline 110 in the marine vessel 100 based on long-term fuel consumption data of the vessel 100, as discussed above. The adjusting is preferably based on long term tank level measurement and/or operating time between refueling of the vessel.

FIG. 5 schematically illustrates, in terms of a number of functional units, the components of a control system 500 according to embodiments of the discussions herein. The control system may be used to implement one or more functions of the control system 170. Processing circuitry 510 is provided using any combination of one or more of a suitable central processing unit CPU, multiprocessor, microcontroller, digital signal processor DSP, etc., capable of executing software instructions stored in a computer program product, e.g., in the form of a storage medium 530. The processing circuitry 510 may further be provided as at least one application specific integrated circuit ASIC, or field programmable gate array FPGA. Particularly, the processing circuitry 510 is configured to cause the control system 500 to perform a set of operations, or steps, such as the methods discussed in connection to FIG. 4 and generally herein. For example, the storage medium 530 may store the set of operations, and the processing circuitry 510 may be configured to retrieve the set of operations from the storage medium 530 to cause the control system 500 to perform the set of operations. The set of operations may be provided as a set of executable instructions. Thus, the processing circuitry 510 is thereby arranged to execute methods as herein disclosed.

The storage medium 530 may also comprise persistent storage, which, for example, can be any single one or combination of magnetic memory, optical memory, solid state memory or even remotely mounted memory.

The control system 500 may further comprise an interface 520 for communications with at least one external device. As such the interface 520 may comprise one or more transmitters and receivers, comprising analogue and digital components and a suitable number of ports for wireline or wireless communication.

The processing circuitry 510 controls the general operation of the control system 500, e.g., by sending data and control signals to the interface 520 and the storage medium 530, by receiving data and reports from the interface 520, and by retrieving data and instructions from the storage medium 530. Other components, as well as the related functionality, of the control node are omitted in order not to obscure the concepts presented herein.

FIG. 6 illustrates a computer readable medium 610 carrying a computer program comprising program code means 620 for performing the methods 5 illustrated in FIG. 4 and the techniques discussed herein, when said program product is run on a computer. The computer readable medium and the code means may together form a computer program product 600.

1. A computer implemented method for determining a fuel consumption of a driveline (110) in a marine vessel (100), the method comprising
generating (S1) a library (210) of fuel consumption models (220, 221, 222), where each fuel consumption model in the library of models is configured to predict fuel consumption of a driveline having a respective specification, where each fuel consumption model in the library of models is configured to operate based on a respective set of sensor input signals (115, 165),
selecting (S2) one or more fuel consumption models from the library (210) based on a specification of the driveline (110) in the marine vessel (100) and on the available sensor input signals of the marine vessel (100),
obtaining (S3) real-time physical sensor input signal data related to the driveline (110) in the marine vessel (100), and
determining (S4) the fuel consumption of the driveline (110) in the marine vessel (100) based on the selected one or more fuel consumption models from the library (210) and on the obtained real-time physical sensor input signal data related to the driveline (110) in the marine vessel (100).

2. The method according to claim 1, where the real-time physical sensor input signal data comprises any of; engine speed, engine torque, engine temperature, engine combustion pressure, engine vibration, and engine sound.

3. The method according to claim 1, where the real-time physical sensor input signal data comprises any of; vessel speed through water, STW, vessel pitch roll and/or yaw, vessel longitudinal acceleration, and vessel lateral acceleration.

4. The method according to claim 1, comprising adjusting (S5) the determined fuel consumption of the driveline (110) in the marine vessel (100) based on long-term fuel consumption data of the vessel (100).

5. The method according to claim 4, where the adjusting is based on long term tank level measurement and/or operating time between refueling of the vessel.

6. The method according to claim 1, where the fuel consumption of the driveline (110) in the marine vessel (100) is determined as a weighted combination of respective outputs from a plurality of fuel consumption models from the library (210) and on the obtained real-time physical sensor input signal data related to the driveline (110) in the marine vessel (100).

7. A control system (180, 500), comprising:
processing circuitry (510);
an interface (530) coupled to the processing circuitry (510); and
a memory (520) coupled to the processing circuitry (510), wherein the memory comprises machine readable computer program instructions that, when executed by the processing circuitry, causes the control system to perform a method according to claim 1.

8. A marine vessel (100) comprising a control system according to claim 7.

9. A computer implemented method for monitoring an output of a physical fuel consumption sensor system configured to monitor a fuel consumption of a driveline (110) in a marine vessel (100), the method comprises
generating a library (210) of fuel consumption models (220, 221, 222), where each fuel consumption model in the library of models is configured to predict fuel consumption of a driveline having a respective specification, where each fuel consumption model in the library of models is configured to operate based on a respective set of sensor input signals (115, 165),
selecting one or more fuel consumption models from the library (210) based on a specification of the driveline (110) in the marine vessel (100) and on the available sensor input signals of the marine vessel (100),
obtaining real-time physical sensor input signal data related to the driveline (110) in the marine vessel (100),
determining the fuel consumption of the driveline (110) in the marine vessel (100) based on the selected one or more fuel consumption models from the library (210) and on the obtained real-time physical sensor input signal data related to the driveline (110) in the marine vessel (100), and monitoring an output of the physical fuel consumption sensor system by comparing its output to the fuel consumption of the driveline determined based on the selected one or more fuel consumption models from the library (210) and on the obtained real-time physical sensor input signal data related to the driveline (110) in the marine vessel (100).
